(19) United States
(12) Patent Application Publication
(10) Pub. No.: US 2024/0048833 A1
(43) Pub. Date: Feb. 8, 2024

(54) APPARATUS HAVING LENS ASSEMBLY ARRAY AND METHOD USING THE SAME

(71) Applicant: SAMSUNG ELECTRONICS CO., LTD., Suwon-si (KR)

(72) Inventors: Kiwoo LEE, Suwon-si (KR); Yang Ho CHO, Suwon-si (KR)

(73) Assignee: SAMSUNG ELECTRONICS CO., LTD., Suwon-si (KR)

(21) Appl. No.: 18/205,290

(22) Filed: Jun. 2, 2023

(30) Foreign Application Priority Data
Aug. 4, 2022 (KR) 10-2022-0097444

(51) Int. Cl. H04N 23/55; H04N 23/69; H04N 23/57

(52) U.S. Cl. CPC H04N 23/55; H04N 23/69; H04N 23/57; H04N 23/687

(57) ABSTRACT

An apparatus having a lens assembly array and a method of using the apparatus are provided. The apparatus includes a lens assembly array including a plurality of lens assemblies each including a plurality of individual lenses in a form of an array, an actuator assembly configured to move at least a portion of the plurality of lens assemblies in at least one direction, and a single image sensor configured to generate image data including a plurality of sub-images corresponding to the plurality of lens assemblies based on light passing through the lens assembly array.

### CROSS-REFERENCE TO RELATED APPLICATION

This application is based on and claims priority from Korean Patent Application No. 10-2022-0097444 filed on Aug. 4, 2022, in the Korean Intellectual Property Office, the disclosure of which is incorporated herein by reference in its entirety.

### BACKGROUND

### 1. Field

Example embodiments of the disclosure relate to an array lens technology, in particular, to imaging apparatuses and methods including an array lens technology.

### 2. Description of the Related Art

Recently, due to the development of optical technology and image processing technology, capturing devices are utilized in a wide range of fields such as multimedia contents, security, and recognition. For example, a capturing device may be mounted on a mobile device, a camera, a vehicle, or a computer to capture an image, recognize an object, or obtain data for controlling a device. The size of the capturing device may be determined based on the size of a lens, the focal length of the lens, and the size of a sensor. When the size of the capturing device is limited, a long focal length may be provided in a limited space through deformation of a lens structure.

### SUMMARY

One or more example embodiments may address at least the above problems and/or disadvantages and other disadvantages not described above. Also, the example embodiments are not required to overcome the disadvantages described above, and an example embodiment may not overcome any of the problems described above.

According to an aspect of the disclosure, there is provided an imaging apparatus, including: a lens assembly array including a plurality of lens assemblies, each of the plurality of lens assemblies including a plurality of individual lenses; an actuator assembly configured to move at least a portion of the plurality of lens assemblies in at least one direction; and a single image sensor configured to generate image data based on light passing through the lens assembly array, the image data including a plurality of sub-images corresponding to the plurality of lens assemblies.

According to another aspect of the disclosure, there is provided an imaging method, including: moving, by an actuator assembly, at least a portion of a lens assembly array including a plurality of lens assemblies, each of the plurality of lens assemblies including a plurality of individual lenses in at least one direction; and generating, by a single image sensor, image data including a plurality of sub-images corresponding to the plurality of lens assemblies based on light passing through the lens assembly array onto the single image sensor.

According to another aspect of the disclosure, there is provided an electronic apparatus including: a lens assembly array including a plurality of lens assemblies, each of the plurality of lens assemblies including a plurality of individual lenses; an actuator assembly configured to move at least a portion of the plurality of lens assemblies in at least one direction; an imaging apparatus configured to be arranged on a first side of the lens assembly array, which is opposite to a light incident side, and including a single image sensor configured to generate image data corresponding to light passing through the lens assembly array; and a processor configured to generate an output image based on the image data.

### BRIEF DESCRIPTION OF THE DRAWINGS

The above and/or other aspects will be more apparent by describing certain example embodiments, taken in conjunction with the accompanying drawings, in which:

FIG. 1 is a diagram illustrating an example of a schematic configuration of an imaging apparatus according to an example embodiment;

FIG. 2 is a cross-sectional view illustrating an example of a structure of an imaging apparatus according to an example embodiment;

FIG. 3 is a diagram illustrating an example of a manufacturing process of an imaging apparatus according to an example embodiment;

FIG. 4 is a diagram illustrating an example of a structure of lens assemblies for efficiently arranging of a sub-imaging area according to an example embodiment;

FIG. 5 is a diagram illustrating an example of an operation of generating an output image from sub-images according to an example embodiment;

FIG. 6 is a diagram illustrating an example of a manufacturing process of an imaging apparatus including an array holder according to an example embodiment;

FIG. 7 is a cross-sectional view illustrating an example of a structure of an imaging apparatus including an individual actuator assembly according to an example embodiment;

FIG. 8 is a flowchart illustrating an example of an imaging method according to an example embodiment; and

FIG. 9 is a block diagram illustrating an example of a structure of an electronic device according to an example embodiment.

### DETAILED DESCRIPTION

Reference will now be made in detail to example embodiments, examples of which are illustrated in the accompanying drawings, wherein like reference numerals refer to the like elements throughout.

The following structural or functional descriptions of examples are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the disclosure.

It will be understood that when a component is referred to as being “connected to” another component, the component can be directly connected or coupled to the other component or intervening components may be present.

As used herein, the singular forms “a”, “an”, and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Unless otherwise defined, all terms used herein including technical or scientific terms have the same meanings as those generally understood consistent with and after an understanding of the disclosure. Terms, such as those defined in commonly used dictionaries, should be construed to have meanings matching with contextual meanings in the relevant art and the disclosure, and are not to be construed as an ideal or excessively formal meaning unless otherwise defined herein.

Hereinafter, examples will be described in detail with reference to the accompanying drawings. When describing the examples with reference to the accompanying drawings, like reference numerals refer to like components and a repeated description related thereto will be omitted.

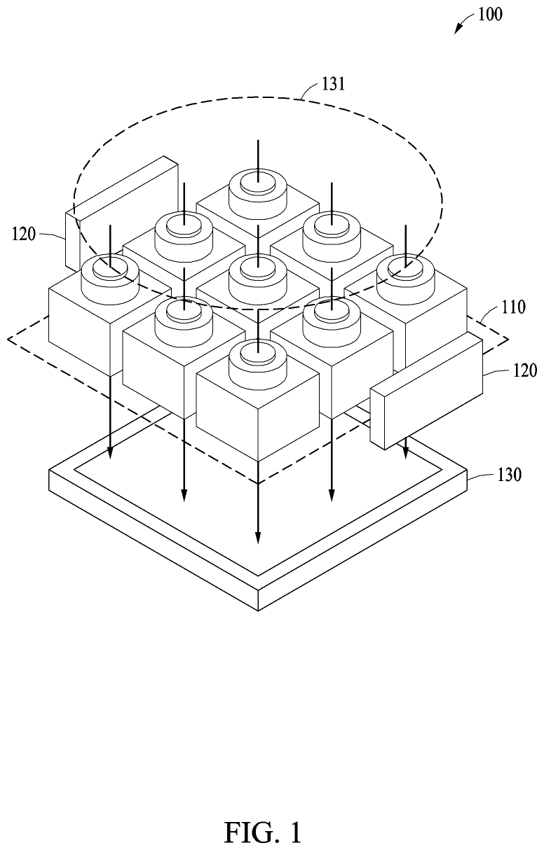

FIG. 1 is a diagram illustrating an example of a schematic configuration of an imaging apparatus according to an example embodiment. Referring to FIG. 1, an imaging apparatus 100 may include a lens assembly array 110, an actuator assembly 120 and an image sensor 130. According to an example embodiment, the imaging apparatus 100 may include a plurality of lens assemblies each including a plurality of individual lenses in a form of an array. According to an example embodiment, the actuator assembly 120 may move at least a portion of the plurality of lens assemblies in at least one direction. According to an example embodiment, the image sensor 130 may be a single image sensor that generates image data including a plurality of sub-images corresponding to the plurality of lens assemblies based on light 131 passing through the lens assembly array.

A number of sub-images may correspond to a number of a plurality of lens assemblies. FIG. 1 illustrates an example in which 9 lens assemblies are arranged in a form of 3*3 array. In this case, 3*3 sub-images may be obtained. However, 3*3 is only an example and various array types such as 2*2 and 4*4 may be used. The sub-images may be synthesized into one output image. The output image may have higher resolution than that of the sub-images.

The imaging apparatus 100 may correspond to an array lens apparatus. An array lens technology is a technology for obtaining a plurality of small images having the same view angle by using a camera configured with a plurality of lenses having a short focal length instead of a camera configured with one aperture or one lens. The thickness of a camera module may be decreased through the array lens technology.

The array lens may be used in various technical fields. The array lens may reduce the size of a camera by dividing a large sensor and a large lens for the large sensor in a form of an array. For example, when a length (that is, a height) of a first camera according to a view angle A, a focal length f, and an image size D is L, a length of a second camera according to a view angle A, a focal length f/2, and an image size D/2 may be reduced to L/2. The resolution of the second camera may be reduced by ¼ compared to that of the first camera. When the second camera is configured with 2*2 array lens and one output image is generated, the resolution may be the same as that of the first camera. More specifically, 4 sub-images may be generated with the 2*2 array lens and an image having the same resolution as that of the first camera may be derived by synthesizing the 4 sub-images.

The lens assembly array 110 may include a plurality of lens assemblies. Each lens assembly may include individual lenses and barrels. A method of capturing an image based on the lens assembly array 110 in the imaging apparatus 100 may be referred to as a lens assembly array method. For example, the array lens apparatus may be configured by arranging lens components in a form of an array to form one layer and then stacking a plurality of the lens component layers to form the array lens apparatus. This method of manufacturing the array lens apparatus may be referred to as a layer stacking method. In the layer stacking method, a shielding wall for shielding interference between lens components may be installed.

A manufacturing error and an assembling error may occur during a manufacturing and an assembling process of each component and the performance (e.g., the resolution) of the optical system may be optimized only when alignment with respect to the optical axis of each component is maintained. In the case of the layer stacking method, a decenter error in which the central axis of the component moves away from the optical axis may be cumulatively increased. Therefore, the layer stacking method is a structure in which it is difficult to maintain uniform resolution. For example, when there is an array lens including 2 layers each having 4 individual lens surfaces, the decenter cumulative error may include a component manufacturing error between an upper surface and a lower surface of a first layer, a position error between individual lenses of the upper surface of the first layer, a position error between individual lenses of the lower surface of the first layer, a component manufacturing error between an upper surface and a lower surface of a second layer, a position error between individual lenses of the upper surface of the second layer, a position error between individual lenses of the lower surface of the second layer, and an assembly decenter error of the first layer and the second layer. Each error may be accumulated differently and applied to the array optical systems. Due to these characteristics, uniformly maintaining the resolution of sub-images imaged through the array optical system may be difficult.

In addition, when three or more lens components are required according to a sensor condition and an F number (Fno) condition, a number of stacked layers may increase, and accordingly, the cumulative tolerance may increase exponentially. Due to this, uniformly maintaining the resolution of the sub-images may be difficult. In addition, when a defect occurs in one lens surface of a certain layer, the entire layer may not be used, and mass production efficiency may be greatly reduced. Due to this, commercializing through mass production may be difficult.

As another example, the array lens apparatus may be configured by arranging a plurality of small cameras in a form of an array. This method of manufacturing the array lens apparatus may be referred to as a camera array method. The camera array method may arrange and fix a plurality of sensors and optical systems in a form of an array. The camera array method may require a separate sensor and an optical filter for each camera, and power consumption, heat, cost, etc., may occur due to a hardware configuration and an operation for driving each sensor. Due to these characteristics, commercializing into a mobile device may be difficult. In addition, the known layer stacking method and the camera array method may have a structure for fixing a focal length.

A variable focal length may be advantageous when a depth of field is short. The depth of field may mean an object distance area having the same resolution based on a focused object distance. For example, when a pixel size 0.8 um sensor is attached to a lens with a focal length of 3.5 mm and the Fno of 1.8 and the focus is on an object with a capturing distance of 1 m, the same resolving power (that is, the resolution) between the capturing distance of 0.8 m and 1.3 m may be obtained. For example, the mobile device may require a possible capturing distance of 10 cm or less (e.g., 1 cm).

The focal length of the array optical system should be less than 1 mm in order to cover the focus from less than 10 cm to a longer distance with a structure that fixes the focal length. In this case, very dark Fno lenses may be excluded. When the focal length is less than 1 mm, at least 2 lenses are required based on a wide-angle of 80 degrees and the image size may be formed of Φ 1.68 mm. With such a configuration, the latest trend of cameras with increasingly large sensors and that include bright lenses may not be met. Implementation of a bright Fno lens requires a lens configuration of 4 or more to reduce aberration and secure resolution, and the layer stacking method may not be suitable for mass production of such a lens configuration. In addition, in order to implement a high-pixel image used in the latest trend in the layer stacking method or the camera array method, a number of N increases in N*N array form, which may cause difficulties in image quality management, production, and cost.

The imaging apparatus 100 may adjust a focal position by controlling the distance between the lens assembly array 110 and the single image sensor 130 through the actuator assembly 120. The adjustment of the focal position may correspond to a focus adjustment or a focusing and may represent a concept different from the adjustment of the focal length. The adjustment of the focal position may refer to adjusting the position of the lens assembly so that the best image is imaged on the image sensor 130, and in this case, a distance and a field of view (FoV) between individual lenses of the lens assembly may be maintained. The adjustment of the focal length may refer to changing the FoV to suit a scene, and in this case, the distance and the FoV between individual lenses of the lens assembly may be changed. In addition, a structure of the imaging apparatus 100 may reduce a manufacturing cost and power consumption and improve management convenience by moving the entire lens assembly array 110 at once through the actuator assembly 120 instead of individually moving each lens assembly of the lens assembly array 110 and providing the single image sensor 130 for the entire lens assembly array 110 instead of providing an individual image sensor for each lens assembly of the lens assembly array 110.

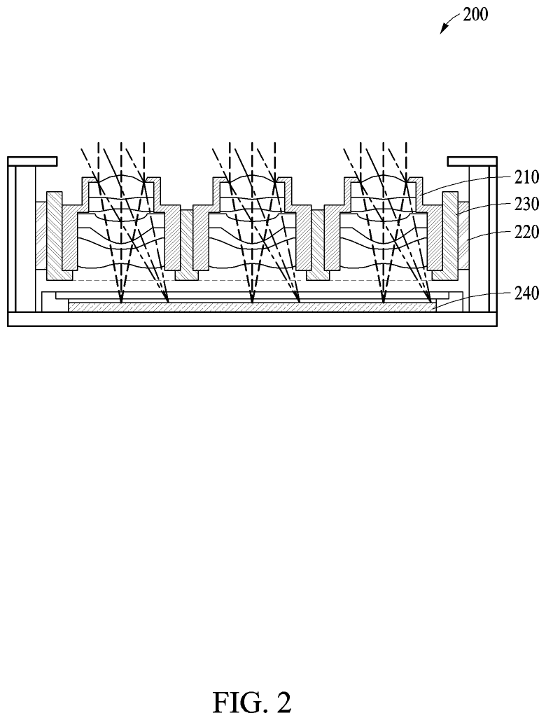

FIG. 2 is a cross-sectional view illustrating an example of a structure of an imaging apparatus according to an example embodiment. Referring to FIG. 2, an imaging apparatus 200 may include a lens assembly 210, an actuator assembly 220, an actuator carrier 230, and a single image sensor 240. The actuator carrier 230 may support a plurality of lens assemblies including the lens assembly 210. In the example embodiment of FIG. 2, a relative position between the plurality of lens assemblies in the lens assembly array may be fixed. The actuator assembly 220 may generate a same movement in the plurality of lens assemblies by moving the actuator carrier 230 in at least one direction. According to the same movement, the plurality of lens assemblies may have a same focal position and a plurality of sub-images may be generated on the single image sensor 240 through the same focal position.

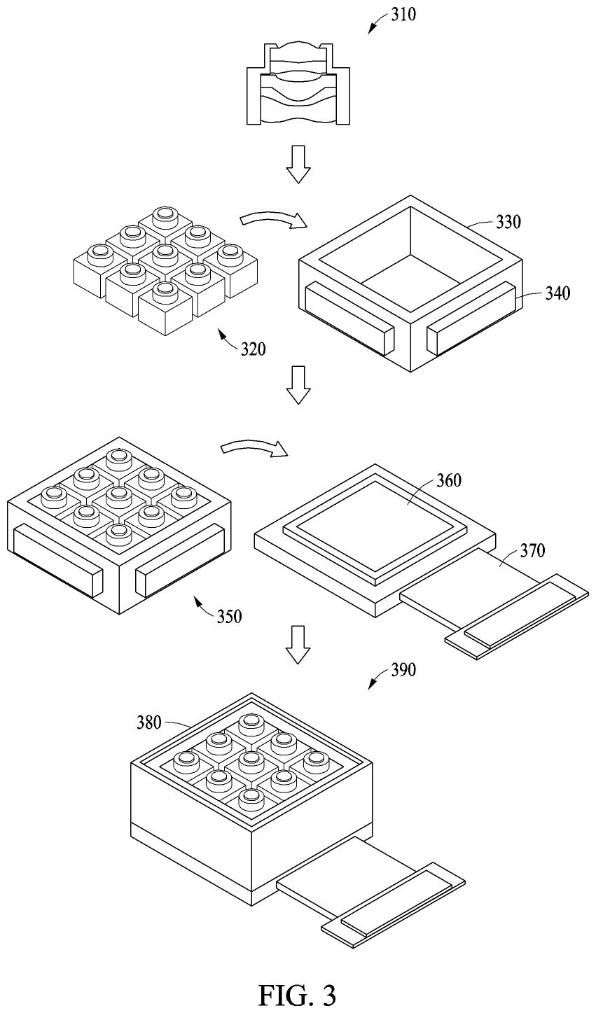

FIG. 3 is a diagram illustrating an example of a manufacturing process of an imaging apparatus according to an example embodiment. Referring to FIG. 3, a lens assembly 310 may be manufactured by assembling a plurality of individual lenses and barrels. FIG. 3 may show an example in which the lens assembly 310 includes 4 individual lenses. When the required size of the array image is determined, characteristics of 2 or more individual lenses of the lens assembly 310 may be determined according to the required Fno and the resolution. The array image may mean an entire image in a form of an array formed on the single image sensor through the lens assembly array.

An actuator assembly 340 may be manufactured to include actuator elements. The actuator assembly 340 may include various elements that may perform at least one of an autofocus function and an optical image stabilizer (OIS) function. For example, the actuator assembly 340 may include at least a portion of a carrier, a magnet, a coil, a ball, a wire, and a hall sensor. The actuator assembly 340 may move the lens assembly array in a vertical direction and/or a horizontal direction with respect to a sensor plane.

A lens assembly array 320 in which a plurality of lens assemblies is arranged in a form of an array may be configured. According to an example embodiment, the lens assemblies of the lens assembly array may have same specification. The description of the lens assembly 310 may also be applied to other lens assemblies of the lens assembly array. The lens assembly array 320 may be inserted into an actuator carrier 330. The actuator carrier 330 may support the lens assembly array 320. The actuator assembly 340 may be attached to the actuator carrier 330. The actuator assembly 340 may move the lens assembly array 320 and/or the actuator carrier 330.

A sub-assembly 350 may include the lens assembly array 320, the actuator carrier 330, and the actuator assembly 340. The sub-assembly 350 may be assembled with a sensor assembly including a single image sensor 360 and a printed circuit board (PCB) and an imaging apparatus 390 may be configured. The sensor assembly may further include an infrared ray (IR) cut filter and the imaging apparatus 390 may further include a housing 380. An active align process may be applied to the assembly of the sub-assembly 350 and the sensor assembly. The active align process may refer to a process in which an assembly operation is performed while maintaining the best resolution by aligning an optical axis with a relative tilt of a lens and a sensor based on an image output from the sensor. The IR cut filter may be attached to the sensor assembly or the actuator carrier 330.

The production of individual lenses of the lens assembly 310, the assembly of the lens assembly 310, the resolution inspection of the lens assembly 310, etc., may be performed in a manner similar to a general manufacturing method of a lens assembly and the lens assembly array 320 may be configured with lens assemblies produced according to a standard. In this way, an imaging apparatus with little resolution difference may be produced. The lens assembly 310 may correspond to a structure that is easy to increase a number of individual lenses. The bright Fno and the large sensor image may be achieved by increasing a number of individual lenses as necessary. For example, 4 or more or 8 individual lenses may be used. The layer stacking method may correspond to a structure that is not suitable for using many individual lenses.

In addition, the imaging apparatus 390 may obtain an image with the best focus by moving the lens assembly array 320 through the actuator assembly 340. For example, a mobile device may require a capturing distance of at least less than or equal to 10 cm. In this case, obtaining a focused image for an object at the capturing distance from less than or equal to 10 cm to a long distance (e.g., an infinity distance) may be required.

The imaging apparatus 390 may perform a capturing when the lens assembly array 320 is at the best focal position of a certain sub-image of the sub-images while moving the lens assembly array 320 in a vertical direction of the sensor plane through the actuator assembly 340, and thus, an image with no blur may be obtained. When an output image is generated by synthesizing the sub-images, a certain sub-image may correspond to a sub-image used as a reference point for synthesis among the sub-images. The actuator assembly 340 may include a component that may move the lens assembly 310 in a horizontal direction of the sensor plane as necessary and provide the OIS function through the component. The actuator assembly 340 may correct a shaking of the imaging apparatus 390 through a movement in the horizontal direction. The movement of the imaging apparatus 390 may be detected by a sensor (e.g., a gyro sensor) that detects the movement of the imaging apparatus 390.

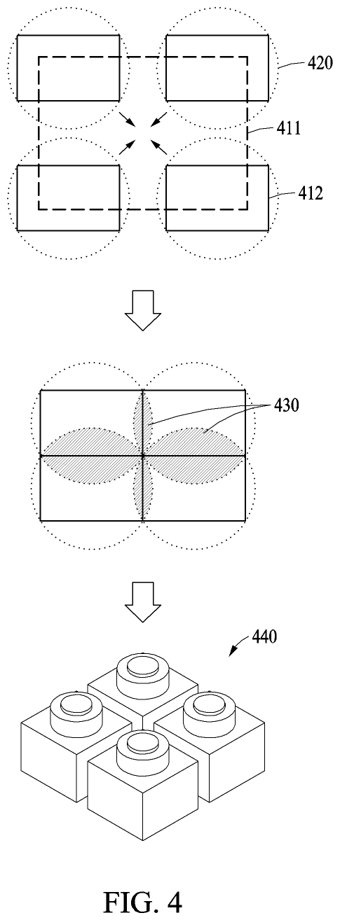

FIG. 4 is a diagram illustrating an example of a structure of lens assemblies for efficiently arranging of a sub-imaging area according to an example embodiment. Referring to FIG. 4, light passing through each lens assembly of the lens assembly array may perform imaging of an array image on an entire sensor plane 411 of a single image sensor. The lens assemblies may have the same specification (e.g., a view angle) and may be configured independently. Each lens assembly may form a sub-image in an area in which the single image sensor is evenly distributed. For example, when the size of the image sensor is 8 mm (H)×6 mm (V), the diagonal length is 10 mm, and an array of 2*2 is used, the image size of each lens assembly is 4 mm (H)×3 mm (V), and the diagonal length may be 5 mm or more.

For the optimal resolution, efficiently arranging the sub-images including a sub-image 412 on the sensor plane 411 without loss of the sensor plane 411 may be required. For this, the sub-images may be required to be in close contact with each other. In this case, during a process of arranging the lens assemblies in close proximity, interference may occur between the lens assemblies. A lens area 420 may represent an area occupied by individual lenses of a certain lens assembly and an interference area 430 may represent an area where interference occurs between lens areas of the lens assemblies.

In the manufacturing process of each lens assembly, at least a portion of the individual lenses corresponding to the interference area 430 may be removed. For example, in a lens assembly array 440, each lens assembly may have a rectangular shape in which a portion causing interference with each other is removed or various other shapes in which the interference area 430 of a long side and the interference area 430 of a short side are removed. The plurality of lens assemblies may be arranged close to each other to minimize space between them according to the individual lenses and the shapes of the lens assembly.

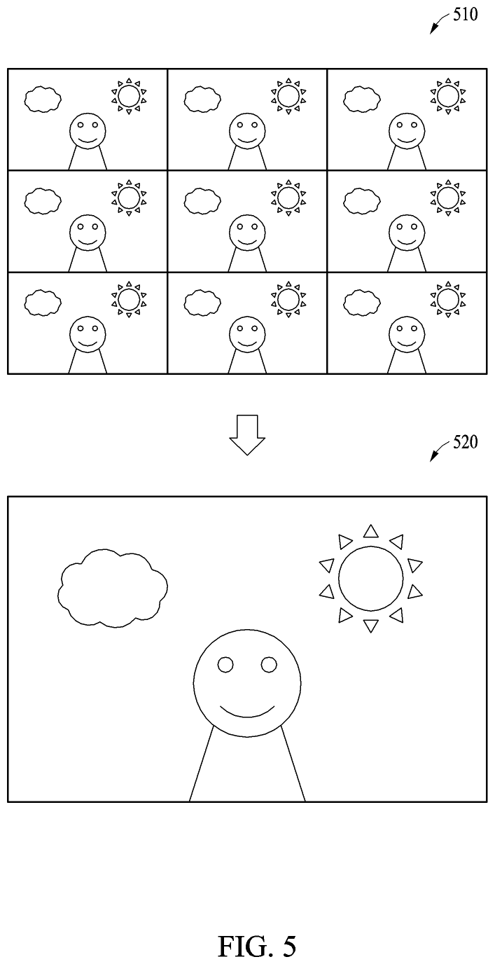

FIG. 5 is a diagram illustrating an example of an operation of generating an output image from sub-images according to an example embodiment. Referring to FIG. 5, sub-images 510 may be formed on the single image sensor through the lens assembly array. Each sub-image of the sub-images 510 may correspond to each lens assembly of the lens assembly array. For example, FIG. 5 may show an example in which 3*3 sub-images 510 are obtained through 3*3 lens assembly array. However, 3*3 is only an example and various array types such as 2*2 and 4*4 may be used. The sub-images 510 may be used as individual images or may be used by synthesizing into one image. When the sub-images 510 are synthesized into one image, the synthesized image may have higher sensitivity and higher resolution than that of the sub-images 510.

The lens assemblies may form different channels with each other and the sub-images 510 may be imaged through the different channels. The capture areas corresponding to the channels may be designated on the sensor plane so that the sub-images 510 imaged on the same sensor plane are distinguished for each channel. The sub-images 510 may be obtained by extracting images for each capture area. For example, when a number of pixels of the single image sensor is 12 Mp (4000*3000) and a 2*2 lens assembly array is used, a 2*2 channel may be defined on the sensor plane. An image output with 12 Mp by the single image sensor may be divided into 4 sub-images corresponding to 3 Mp (2000*1500) of each channel and one high-resolution image may be generated by matching the four sub-images. A multi-image super-resolution (SR) image may be generated through the SR using a plurality of images as necessary.

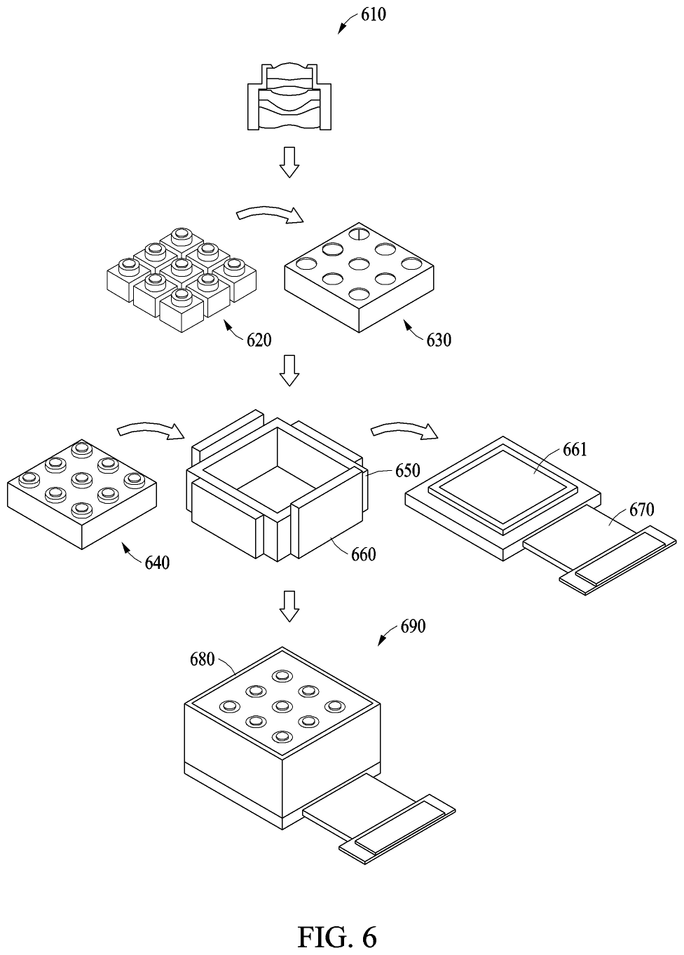

FIG. 6 is a diagram illustrating an example of a manufacturing process of an imaging apparatus including an array holder according to an example embodiment. Referring to FIG. 6, an imaging apparatus 690 may further include an array holder 630 compared to the imaging apparatus 390 of FIG. 3. When a lens assembly array 620 is manufactured based on a lens assembly 610, a relative position between the lens assemblies of the lens assembly array 620 may be fixed through the array holder 630.

The lens assemblies may be inserted into an actuator carrier 650 while being contained in the array holder 630. The lens assemblies may be supported by the actuator carrier 650 while being contained in the array holder 630. The lens assembly array 620 and the array holder 630 may form a sub-assembly 640. An actuator assembly 660 may be attached to the actuator carrier 650. The assembly of the sub-assembly 640, the actuator carrier 650, and the actuator assembly 660 may be attached to the sensor assembly including a single image sensor 661 and the PCB, and the imaging apparatus 690 may be completed through a cover of a housing 680. The description of the imaging apparatus 390 of FIG. 3 may be applied to the imaging apparatus 690 as necessary.

The array holder 630 may function to fix a relative position of the lens assemblies until the sub-assembly 640 is inserted into the actuator carrier 650. Without the array holder 630, at least a portion of the lens assemblies in the lens assembly array 620 may move and the relative position between the lens assemblies may be changed. For example, when a manufacturing process of the sub-assembly 640 is separated from the rest of the manufacturing process, the relative position until the sub-assembly 640 is inserted into the actuator carrier 650 after the sub-assembly 640 is manufactured may be changed. For the optimal performance of the imaging apparatus 690 such as forming a focus on the same sensor plane, the lens assembly array 620 may be required to fix the relative position between the lens assemblies. The change in the relative position may degrade the performance of imaging apparatus 690. When the manufacturing of the sub-assembly 640 is completed, fixing the relative position through the array holder 630 after quality inspection may be a method to minimize manufacturing defects.

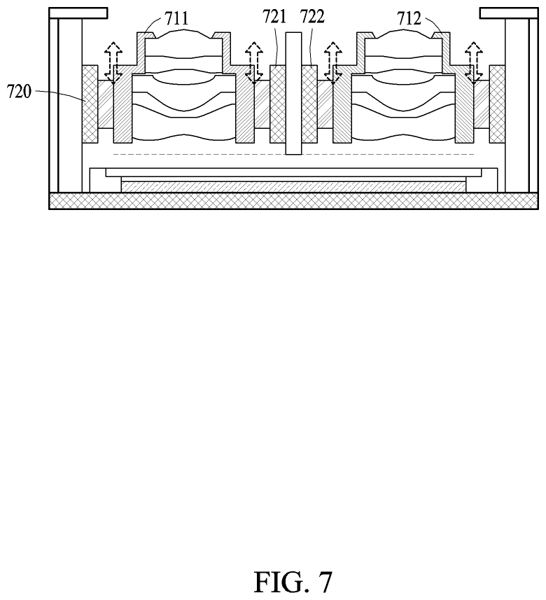

FIG. 7 is a cross-sectional view illustrating an example of a structure of an imaging apparatus including an individual actuator assembly according to an example embodiment. Referring to FIG. 7, an actuator assembly set 720 may include a first individual actuator assembly 721 and a second individual actuator assembly 722. The first individual actuator assembly 721 may be used to move a first lens assembly 711 and the second individual actuator assembly 722 may be used to move a second lens assembly 712. As such, the actuator assembly set 720 may include individual actuator assemblies corresponding to each lens assembly of the lens assembly layer and each lens assembly may be individually controlled through the individual actuator assemblies. According to an example embodiment, not all lens assemblies are individually controlled but individual control may be performed for each group of lens assemblies. For example, 3 groups of 1*3 may be configured in 3*3 array and individual control may be performed for each group.

In the example of FIG. 7, a relative position between the plurality of lens assemblies 711 and 712 in the lens assembly array may be variable. The actuator assembly set 720 may generate a different movement in the plurality of lens assemblies 711 and 712. The sub-images of various focus may be generated according to the different movement. For example, a first sub-image among the plurality of sub-images may be generated through a focal position different from a second sub-image among the plurality of sub-images. The first sub-image may be generated based on the first lens assembly 711 and the first individual actuator assembly 721, and the second sub-image may be generated based on the second lens assembly 712 and the second individual actuator assembly 722. An imaging apparatus using an extended depth of focus through various focusing may be implemented.

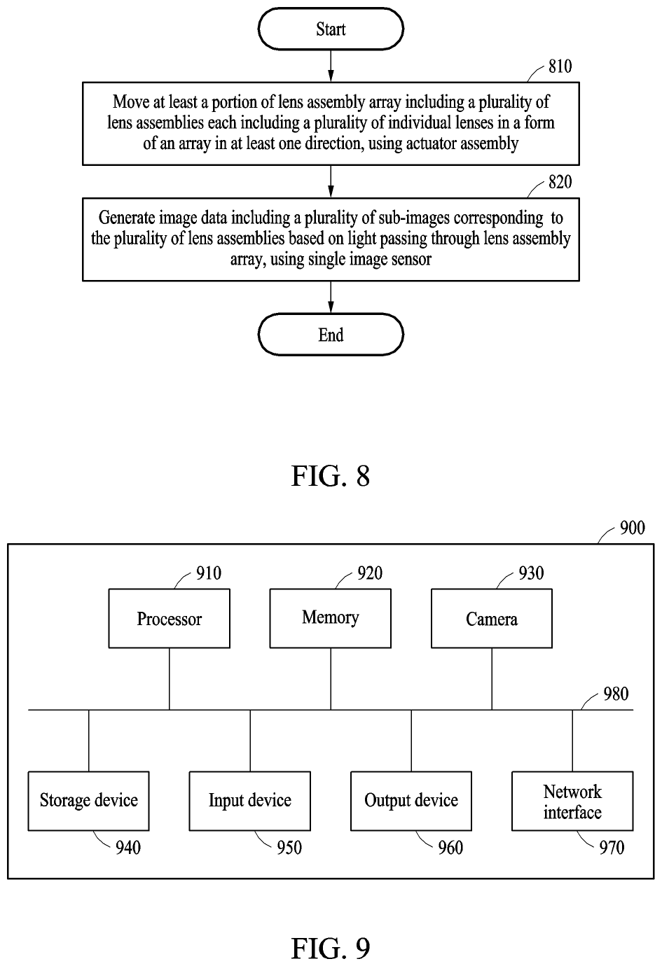

FIG. 8 is a flowchart illustrating an example of an imaging method according to an example embodiment. Referring to FIG. 8, in operation 810, the imaging apparatus may move at least a portion of the lens assembly array including a plurality of lens assemblies using the actuator assembly. According to an example embodiment, each of the plurality of lens assemblies include a plurality of individual lenses in a form of an array in at least one direction. In operation 820, the imaging apparatus may generate image data including a plurality of sub-images corresponding to the plurality of lens assemblies based on light passing through the lens assembly array, using a single image sensor.

The relative position between the plurality of lens assemblies in the lens assembly array may be fixed and generating a same movement in the plurality of lens assemblies may be included in operation 810. According to the same movement, a plurality of sub-images may be generated through a same focal position.

The relative position between the plurality of lens assemblies in the lens assembly array may be variable and the actuator assembly may include generating a different movement in the plurality of lens assemblies in operation 810. According to the different movement, the first sub-image among the plurality of sub-images may be generated through a focal position different from the second sub-image among the plurality of sub-images.

The plurality of lens assemblies may be supported by an actuator carrier supporting the plurality of lens assemblies while being contained in an array holder fixing the relative position between the plurality of lens assemblies.

The plurality of lens assemblies may be arranged in close proximity so that the plurality of sub-images may be in close contact with each other in the single image sensor and at least a portion of the plurality of individual lenses causing interference in a process of the close arrangement of the plurality of lens assemblies may be removed.

In addition, the description provided with reference to FIGS. 1 to 7 and 9 may be applied to the imaging method of FIG. 8.

FIG. 9 is a block diagram illustrating an example of a structure of an electronic device according to an example embodiment. Referring to FIG. 9, an electronic device 900 may include a processor 910, a memory 920, a camera 930, a storage device 940, an input device 950, an output device 960, and a network interface 970, and may communicate with each other via a communication bus 980. For example, the electronic device 900 may be embodied as at least a portion of a mobile device (e.g., a mobile phone, a smartphone, a personal digital assistant (PDA), a netbook, a tablet computer, a laptop computer, etc.), a wearable device (e.g., a smartwatch, a smart band, smart eyeglasses, etc.), a computing device (e.g., a desktop, a server, etc.), a home appliance (e.g., a television (TV), a smart TV, a refrigerator, etc.), a security device (e.g., a door lock, etc.), or a vehicle (e.g., an autonomous vehicle, a smart vehicle, etc.).

The processor 910 may execute instructions and functions in the electronic apparatus 900. For example, the processor 910 may process instructions stored in the memory 920 or the storage device 940. The processor 910 may perform at least one of the operations described above with reference to FIGS. 1 through 8. For example, the processor 910 may control the camera 930 and generate an output image based on image data provided by the camera 930. The output image may be stored by the memory 920 and/or the storage device 940 or may be output by the output device 960. The memory 920 may include a non-transitory computer-readable storage medium or a non-transitory computer-readable storage device. The memory 920 may store instructions that are to be executed by the processor 910, and also store information associated with software and/or applications when the software and/or applications are being executed by the electronic device 900.

The camera 930 may capture a photo and/or a video. The camera 930 may structurally and/or functionally include at least a portion of the imaging apparatus 100 of FIG. 1, the imaging apparatus 200 of FIG. 2, the imaging apparatus 390 of FIG. 3, the imaging apparatus 690 of FIG. 6, and the imaging apparatus of FIG. 7. The storage device 940 may include a non-transitory computer-readable storage medium or a non-transitory computer-readable storage device. The storage device 940 may store a greater amount of information than the memory 920 and store the information for a long period of time. For example, the storage device 940 may include magnetic hard disks, optical disks, flash memories, floppy disks, or other forms of non-volatile memories known in the art.

The input device 950 may receive an input from a user through a traditional input scheme using a keyboard and a mouse, and through a new input scheme such as a touch input, a voice input, and an image input. For example, the input device 950 may detect an input from a keyboard, a mouse, a touchscreen, a microphone, or a user, and may include any other device configured to transfer the detected input to the electronic apparatus 900. The output device 960 may provide a user with an output of the electronic apparatus 900 through a visual channel, an auditory channel, or a tactile channel. The output device 960 may include, for example, a display, a touchscreen, a speaker, a vibration generator, or any other device configured to provide a user with the output. The network interface 970 may communicate with an external device via a wired or wireless network.

The examples described herein may be implemented using hardware components, software components and/or combinations thereof. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

Software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

What is claimed is:

1. An imaging apparatus, comprising:
a lens assembly array comprising a plurality of lens assemblies, each of the plurality of lens assemblies comprising a plurality of individual lenses;
an actuator assembly configured to move at least a portion of the plurality of lens assemblies in at least one direction; and
a single image sensor configured to generate image data based on light passing through the lens assembly array, the image data comprising a plurality of sub-images corresponding to the plurality of lens assemblies.

2. The imaging apparatus of claim 1, wherein a relative position between the plurality of lens assemblies in the lens assembly array is configured to be fixed,
wherein the actuator assembly is configured to generate a same movement to the plurality of lens assemblies.

3. The imaging apparatus of claim 2, wherein the plurality of sub-images is generated through a same focal position according to the same movement.

4. The imaging apparatus of claim 1, further comprising:
an actuator carrier configured to support the plurality of lens assemblies,
wherein the actuator assembly is configured to generate a movement in the plurality of lens assemblies by moving the actuator carrier in the at least one direction.

5. The imaging apparatus of claim 4, further comprising:
an array holder configured to fix a relative position between the plurality of lens assemblies,
wherein the actuator carrier is configured to support the plurality of lens assemblies contained in the array holder.

6. The imaging apparatus of claim 1, wherein a relative position between the plurality of lens assemblies in the lens assembly array is configured to be variable,
wherein the actuator assembly is configured to generate a different movement in the plurality of lens assemblies.

7. The imaging apparatus of claim 6, wherein, according to the different movement, a first sub-image of the plurality of sub-images is generated through a first focal position and a second sub-image of the plurality of sub-images is generated through a second focal position different from the first focal position.

8. The imaging apparatus of claim 1, wherein the plurality of lens assemblies is configured to be arranged in close proximity so that the plurality of sub-images is in close contact with each other in the single image sensor.

9. The imaging apparatus of claim 8, wherein the plurality of individual lenses are configured in an arrangement that avoids interference between the plurality of sub-images.

10. The imaging apparatus of claim 1, wherein a number of the plurality of sub-images is configured to correspond to a number of the plurality of lens assemblies.

11. The imaging apparatus of claim 1, wherein the actuator assembly is configured to perform at least one of an autofocus function and an optical image stabilizer (OIS) function.

12. An imaging method, comprising:
moving, by an actuator assembly, at least a portion of a lens assembly array comprising a plurality of lens assemblies, each of the plurality of lens assemblies comprising a plurality of individual lenses in at least one direction; and
generating, by a single image sensor, image data comprising a plurality of sub-images corresponding to the plurality of lens assemblies based on light passing through the lens assembly array onto the single image sensor.

13. The imaging method of claim 12, wherein a relative position between the plurality of lens assemblies in the lens assembly array is configured to be fixed,
wherein the moving of at least the portion of the lens assembly array comprises generating a same movement in the plurality of lens assemblies.

14. The imaging method of claim 13, wherein the plurality of sub-images is generated through a same focal position according to the same movement.

15. The imaging method of claim 12, wherein a relative position between the plurality of lens assemblies in the lens assembly array is configured to be variable,
wherein the moving of at least a portion of the lens assembly array comprises generating a different movement in the plurality of lens assemblies.

16. The imaging method of claim 15, wherein a first sub-image of the plurality of sub-images is configured to be generated through a focal position different from a second sub-image of the plurality of sub-images according to the different movement.

17. The imaging method of claim 12, wherein the plurality of lens assemblies is supported by an actuator carrier while the plurality of lens assemblies is contained in an array holder fixing a relative position between the plurality of lens assemblies.

18. The imaging method of claim 12, wherein the plurality of lens assemblies is configured to be arranged in close proximity so that the plurality of sub-images is in close contact with each other in the single image sensor,
wherein at least a portion of the plurality of individual lenses causing interference between the plurality of sub-images is removed.

19. An electronic apparatus comprising:
a lens assembly array comprising a plurality of lens assemblies, each of the plurality of lens assemblies comprising a plurality of individual lenses;
an actuator assembly configured to move at least a portion of the plurality of lens assemblies in at least one direction;
an imaging apparatus configured to be arranged on a first side of the lens assembly array, which is opposite to a light incident side, and comprising a single image sensor configured to generate image data corresponding to light passing through the lens assembly array; and
a processor configured to generate an output image based on the image data.

20. The electronic apparatus of claim 19, wherein the image data comprises sub-images corresponding to a number of the plurality of lens assemblies,
wherein the processor is configured to generate the output image by synthesizing the sub-images into a single image.
